(19) United States
(12) Patent Application Publication
(10) Pub. No.: US 2014/0257630 A1
(43) Pub. Date: Sep. 11, 2014

(54) SAFETY DOOR INTERLOCK SYSTEM FOR PUBLIC TRANSPORTATION VEHICLES

(71) Applicant: XEROX CORPORATION, Norwalk, CT (US)

(72) Inventors: Erwin Ruiz, Rochester, NY (US); Michael W. Schab, Rochester, NY (US); Eliud Robles Flores, Webster, NY (US); Roberto Ramos, III, East Rochester, NY (US)

(73) Assignee: XEROX Corporation, Norwalk, CT (US)

(21) Appl. No.: 13/784,951

(22) Filed: Mar. 5, 2013

(51) Int. Cl. E05B 65/12

(52) U.S. Cl. CPC E05B 81/62
USPC 701/36

(57) ABSTRACT

A vehicle door interlock system includes a logic processor operatively connected to a door of a vehicle positioned with respect to a pedestrian egress path. A first input to the logic processor comprises a velocity detection signal that determines a velocity of the vehicle. A second input comprises an object detection signal that determines movement of an object toward the vehicle, travelling along a path that would pass in front of the door. A third input comprises an open door signal. The logic processor provides a signal to an interlock device to prevent the door from being opened when the logic processor determines any one of: the vehicle moving based on the velocity detection signal, the object being at a distance and moving in a direction to intersect the pedestrian egress path based on the object detection signal, and lack of open door signal from the operator of the vehicle.

### BACKGROUND

Systems and methods herein generally relate to door actuating systems, and more particularly to a safety interlock system for a passenger vehicle door to assure safe conditions prior to opening of the vehicle door for exit from the vehicle.

Many public transportation vehicles typically rely on passive systems such as signs or lights in order to alert upcoming vehicles that passenger are loading or unloading the vehicles. In some transit systems, such as the Toronto TTC streetcar, the trolley lane may be in the middle of the road with moving traffic on both sides of the streetcar. Passengers may potentially have to load/unload the trolley while a nearby car may be in motion.

According to the National Highway Transportation Safety Administration, pedestrian fatalities while loading and unloading school buses account for approximately three times as many fatalities as when the passengers are on board the bus. Younger children are particularly vulnerable to fatal pedestrian school bus accidents according to the Transportation Research Board.

In some cases, it has been found that the school bus door was opened by the passenger or some other individual before the school bus had reached a complete stop. In other cases, it has been found that the door was opened after the bus had reached a complete stop, but before the driver could check and make sure that all following and oncoming traffic had stopped. In all cases, both the passenger and the driver have a responsibility to avoid an accident.

In most, if not all, of these cases, the resulting injury or fatality could have been avoided if proper safety precautions had been taken. Some systems, such as school buses, utilize flashing lights and a stop sign that flips in front of adjacent traffic lanes, in order to alert the upcoming traffic that passengers are loading/unloading the vehicle. The above-mentioned systems rely on stop sign labels and common sense from the passengers/drivers in order to avoid an unsafe situation.

None of those systems can truly avoid a close encounter from an upcoming vehicle and a passenger.

### SUMMARY

Systems and methods described herein disclose a door interlock system that uses a monitoring system to detect the presence of an upcoming vehicle and its speed in order to determine if it is safe or not to exit the vehicle. If there is a vehicle moving close to the exit door, the interlock system will trigger an interlock mechanism to keep the exit door closed. If there are not any moving vehicles adjacent to the exit door, the door can operate normally.

According to a vehicle door interlock system, a logic processor is operatively connected to a door of a vehicle. The door is positioned with respect to a pedestrian egress path out of the vehicle. The logic processor has a plurality of inputs. A first input comprises a velocity detection signal from a velocity sensor operatively connected to the vehicle determining a velocity of the vehicle. A second input comprises an object detection signal from a motion sensor attached to an outside portion of the vehicle. The motion sensor determines movement of an object relative to the pedestrian egress path. A third input comprises an open door signal from an operator of the vehicle. The logic processor provides a signal to an interlock device operatively connected to the door of the vehicle. The interlock device prevents the door from being opened when the logic processor determines any one of: the vehicle moving based on the velocity detection signal, the object being at a distance and moving in a direction to intersect the pedestrian egress path based on the object detection signal, and lack of the open door signal from the operator of the vehicle.

According to an apparatus herein, a first sensor is operatively connected to a vehicle. The first sensor determines a velocity of the vehicle. A second sensor is attached to an outside portion of the vehicle. The second sensor detects movement of an object relative to a pedestrian egress path out of the vehicle. A logic system is operatively connected to the first sensor and the second sensor. The logic system provides a signal to an interlock device operatively connected to a door of the vehicle. The interlock device prevents the door from being opened when the logic system determines one of: the vehicle being moving based on input from the first sensor, and the object being at a distance and moving in a direction to intersect the pedestrian egress path based on input from the second sensor.

According to an interlock system for a vehicle door, a sensor is operatively attached to an outside portion of a vehicle. The sensor detects an object moving toward the vehicle when stationary. A processor is operatively connected to the sensor. Responsive to the sensor determining that the object is within a predetermined distance from the vehicle door and that the object is travelling along a path that would pass in front of the door approximately perpendicular to a direction of pedestrian egress from the vehicle, the processor triggers an interlock mechanism preventing the vehicle door from being opened.

According to a door control apparatus herein, an interlock mechanism is operatively connected to a door of a vehicle. A velocity sensor is operatively connected to the vehicle. The velocity sensor determines a velocity of the vehicle. A motion sensor is attached to an outside portion of the vehicle. The motion sensor detects movement of an object moving toward the vehicle. A processor is operatively connected to the velocity sensor and the motion sensor. The processor triggers the interlock mechanism to prevent the door from being opened when the processor determines the vehicle is moving based on input from the velocity sensor and the object is within a predetermined distance from the vehicle and travelling along a path that would pass in front of the door approximately perpendicular to a direction of pedestrian egress from the vehicle based on input from the motion sensor.

These and other features are described in, or are apparent from, the following detailed description.

### BRIEF DESCRIPTION OF THE DRAWINGS

Various exemplary devices and methods of the systems and methods are described in detail below, with reference to the attached drawing figures, in which:

FIG. 1 is a block diagram of a vehicle having an interlock device according to devices and methods herein;

FIG. 2 is a high level block diagram of a controller according to devices and methods herein; and

FIG. 3 is a flow diagram illustrating devices and methods herein.

### DETAILED DESCRIPTION

The disclosure will now be described by reference to a preferred apparatus that includes a door interlock system employing a motion sensor. While the disclosure will be described hereinafter in connection with specific devices and methods thereof, it will be understood that limiting the disclosure to such devices and methods is not intended. On the contrary, it is intended to cover all alternatives, modifications, and equivalents as may be included within the spirit and scope of the disclosure as defined by the appended claims.

For a general understanding of the features of the disclosure, reference is made to the drawings. In the drawings, like reference numerals have been used throughout to identify identical elements.

According to devices and methods herein, a door interlock system uses an upcoming vehicle speed monitoring system to determine if it is safe or not to exit the vehicle. The vehicle could be a school bus, other forms of public transportation, such as a commercial trolley vehicle, or a passenger vehicle. If there is another vehicle moving close to the exit door, the door interlock system will trigger an interlock mechanism to keep the exit door closed. If there are no moving vehicles adjacent to the exit door, the door interlock system will permit opening of the exit door. According to devices and methods herein, the door interlock system may also include safety overrides and visual and/or audible warnings, as well as the door interlock.

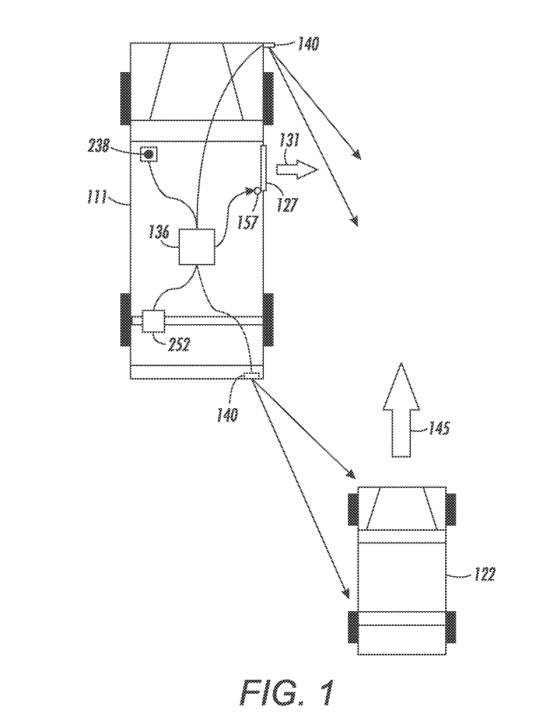

Referring to FIG. 1, a vehicle 111, such as a public transportation bus, is shown. An object 122 in the vicinity of the vehicle 111 is sometimes referred to herein as an approaching vehicle. The vehicle 111 has a door 127 that allows passengers to enter or exit the vehicle 111. The door 127 is positioned with respect to a pedestrian egress path, depicted by arrow 131, in order to block the egress path 131 when the door 127 is closed and to not block the egress path 131 when the door 127 is opened. The vehicle 111 further includes a motion sensor 140 attached to an outside portion of the vehicle 111. The motion sensor 140 detects motion of the approaching object 122. There may be a sensor at the front or rear of the vehicle 111 or, depending on the application, there may be sensors located at both the front and rear of the vehicle 111 in order to provide desired coverage.

In general, the motion sensor 140 may be any speed detection apparatus adapted to detect the presence, range, and relative velocity of an object 122. The motion sensor 140 can utilize available technologies in order to monitor the speed of traffic adjacent to the vehicle 111. Some of the commercial motion sensors are Ka radars, Doppler radars, ultrasonic, proximity sensors, or laser sensors. In one example, the motion sensor 140 can be a radar system. The radar systems may include components known in the art such as antennas, transmitters, receivers, exciters, antennae beam pointing devices, timing and control units, signal processors, data processors, control and display units, and the like. The antennae may be any device adapted to provide spatial directivity to a transmitted electromagnetic wave and then to intercept the scattering of that wave from the target. In some examples, the antennae may be a mechanically scanning or electronically scanning antennae such as a phased array and frequency scanned antennae. According to devices and methods herein, the transmitters may be solid-state devices adapted to amplify waveforms to a power level sufficient for target detection and estimation. The receiver and exciter provide a subsystem containing the precision timing and frequency reference source or sources used to derive a master oscillator and local oscillator referenced frequencies. The exciter generates waveforms for subsequent transmission.

According to devices and methods herein, the motion sensor 140 may comprise a laser rangefinder capable of rapidly scanning the environment in the direction of an approaching vehicle. More than one laser rangefinder may be used, if appropriate. The laser rangefinder, using technology sometimes known as light detection and ranging (LIDAR), directs a laser beam from the vehicle 111 into the environment, receiving from an object 122 in the path of the laser beam, such as an approaching vehicle, a reflection of the laser beam. The received laser beam reflections are analyzed to obtain information about the object from which the laser beam is being reflected. Analysis of the laser beam reflections can include range gating the received laser beam reflections to limit analysis of the received laser beam reflections to only those received from the object 122 within a defined (distance) range, such that objects at distances within the range are isolated from surrounding objects.

Further, as is known in the art, based on reflections from the object 122, the motion sensor 140 can differentiate an object 122 being within a preselected size range, such as a car or bus as opposed to a pedestrian or bicycle. The motion sensor 140 can also determine the speed and direction of travel of the object 122.

The motion sensor 140 provides an object detection signal to a vehicle door interlock system 136. If the motion sensor 140 indicates that the object 122 is travelling above a preselected speed along a path, as depicted by arrow 145, that would pass in front of the door 127 and which would intersect the pedestrian egress path 131 from the vehicle, the vehicle door interlock system 136 triggers a door interlock 157, disabling operation of the door 127. The path 145 of the approaching vehicle may be approximately perpendicular to the pedestrian egress path 131. Once the door 127 has been interlocked, a passenger will be unable to open the door 127 and exit the vehicle 111. This will effectively insure that the approaching object 122 will not hit the passenger exiting the vehicle 111.

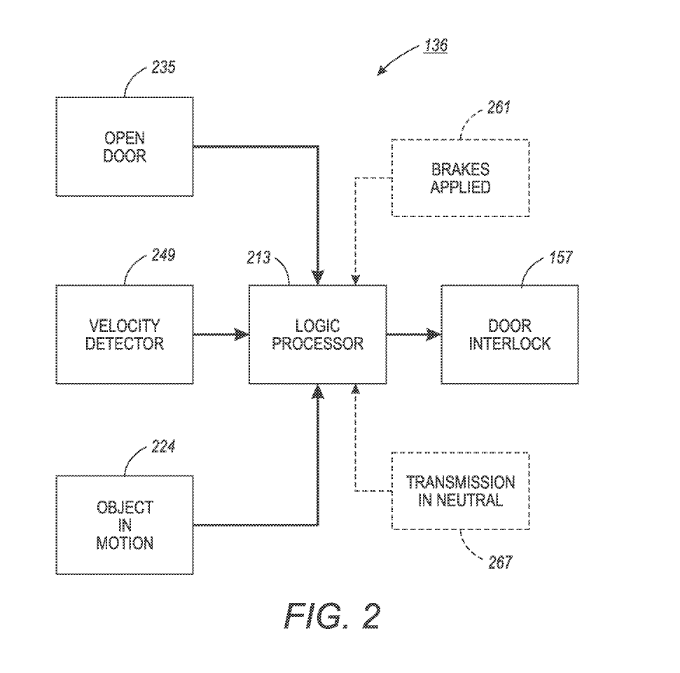

As shown in FIG. 2, the vehicle door interlock system 136 can include a logic processor 213 operatively connected to the door 127. The logic processor 213 has several inputs, each of which can trigger the door interlock 157. For example, in addition to the Object Detection signal 224 from the motion sensor 140, as described above, an Open Door signal 235 may be used. The Open Door signal 235 comes from a manually actuated driver control open door switch indicated by 238 in FIG. 1. The open door switch 238, as shown in FIG. 1, may be placed in close proximity to a driver station in the vehicle 111 such that the open door switch 238 can be reached and operated by the driver. When the driver has stopped the vehicle 111, the driver can engage the open door switch 238 so that the door 127 can be opened by the operator or by a passenger desiring to egress. In practice, the Open Door signal 235 to the logic processor 213 may provide a remote signal from the driver to open the door 127 or a permissive signal to allow the door 127 to be opened locally by a passenger. According to devices and methods herein, without the Open Door signal 235, the door 127 cannot be opened locally or remotely.

Another input to the logic processor 213 may include a Velocity Detection signal 249 indicating that the vehicle 111 is stopped. The Velocity Detection signal 249 may come from a velocity detection apparatus indicated by 252 in FIG. 1. The basic function of the velocity detection apparatus 252 is to detect when the vehicle 111 is stationary or travelling at rate of speed equal to or less than a predetermined speed, referred to as the ‘zero speed’, and to send a Velocity Detection signal 249 to the logic processor 213 when the velocity detection apparatus 252 determines the vehicle 111 is stopped. If the zero speed condition exists, the velocity detection apparatus 252 sends the Velocity Detection signal 249 to the logic processor 213, which will allow the door 127 to be opened, if other conditions exist. If the zero speed condition does not exist, the velocity detection apparatus 252 does not send the Velocity Detection signal 249 to the logic processor 213, so the door 127 cannot be opened. According to devices and methods herein, the velocity detection apparatus 252 may comprise a tachometer attached to one or more axles of the vehicle 111, or a velocity sensor operatively connected to the vehicle 111. Other methods and devices can be used.

Other inputs to the logic processor 213, such as the brakes of the vehicle 111 being applied 261, the transmission being in a neutral position 267, or other conditions as now known or developed in the future, may be incorporated into the vehicle door interlock system 136.

The vehicle door interlock system 136, as disclosed herein, cooperates with the door 127 and the door interlock 157 so as to lock the door 127 in its closed position, thereby assuring that the door 127 cannot be inadvertently opened unless the vehicle door interlock system 136 indicates a safe condition. The door interlock 157 includes a locking mechanism that is adapted to engage and lock the door 127 in a closed position blocking the egress path 131, but which is adapted to release the locking mechanism upon the occurrence of selected events in order that the door 127 can be opened. According to devices and methods herein, the door interlock 157 may comprise a mechanical solenoid, a pneumatic valve, or other similar devices that trigger a locking link to actuate a door lock.

Additionally, the vehicle door interlock system 136 can also provide a control to enable the driver to override the already installed door opening mechanism in order to interrupt the functionality.

According to devices and methods herein, the vehicle door interlock system 136 may include an alarm, light, sound, or other indication, in order to signal the passenger that it is not clear to exit the vehicle 111. Other secondary actions may include providing a signal to the driver of the approaching vehicle or taking a picture of the license plate of the approaching vehicle, as appropriate.

Upon coming to a stop to load or unload passengers, the Velocity Detection signal 249 is provided to the logic processor 213. The driver of the vehicle 111 toggles the Open Door signal 235 to the logic processor 213. If the motion sensor 140 indicates no object detection, or that an approaching object 122 is not near or not in motion, that is, the object 122 is not within a predetermined distance from the vehicle 111 and travelling along a path 145 that would pass in front of the door 127 intersecting the pedestrian egress path 131 from the vehicle 111, the Object Detection signal 224 is provided to the logic processor 213. If all the inputs are present, that is the vehicle 111 is stopped, the driver has signaled to open the door 127, and there is no nearby vehicle in motion, a safe condition exists. The logic processor 213 then enables the vehicle door interlock system 136 to release the door interlock 157 in order to permit operation of the door 127. Once any of those conditions no longer exists, the interlock function becomes activated such that, when the door 127 is closed, the door 127 remains locked, blocking the pedestrian egress path 131, until the vehicle door interlock system 136 releases the door interlock 157 again.

According to devices and methods herein, the vehicle door interlock system 136 includes a logic processor 213 operatively connected to the door 127 of a vehicle, such as vehicle 111. The logic processor 213 has a plurality of inputs. A first input may comprise an open door signal 235 from an operator of the vehicle 111. A second input may comprise a velocity detection signal indicating the vehicle 111 is stopped. A third input may comprise a motion-detecting signal indicating no nearby vehicle is in motion from a motion sensor 140 determining whether an approaching vehicle is nearby the door 127 of the vehicle 111. The logic processor 213 provides a signal to a door interlock 157 operatively connected to the door 127 of the vehicle 111 permitting the door 127 to be opened when the logic processor 213 determines the vehicle 111 is moving based on input from a velocity detection apparatus 252 and detects motion of the object 122 within a predetermined distance from the vehicle 111 based on input from the motion sensor 140. The motion of the object 122 is detected along a path 145 that would pass in front of the door 127, approximately perpendicular to the direction of the pedestrian egress path 131 from the vehicle.

According to a door control apparatus herein, an interlock mechanism is operatively connected to a door 127 of a vehicle 111. A velocity detection apparatus 252 or velocity sensor is operatively connected to the vehicle 111. The velocity sensor determines a velocity of the vehicle 111. A motion sensor 140 is attached to an outside portion of the vehicle 111. The motion sensor detects movement of an object 122 moving toward the vehicle 111. A logic processor 213 is operatively connected to the velocity sensor and the motion sensor 140. The processor triggers the door interlock 157 to prevent the door 127 from being opened from inside the vehicle 111 when the logic processor 213 determines the vehicle 111 is moving based on input from the velocity sensor and the object 122 is within a predetermined distance from the vehicle and travelling along a path 145 that would pass in front of the door 127 approximately perpendicular to the direction of the pedestrian egress path 131 from the vehicle 111 based on input from the motion sensor 140.

Therefore, it is appreciated that according to the safety interlock system described herein, to disengage the door interlock 157 in order to open the door 127, the open door switch 238 must be actuated, the velocity detection apparatus 252 must indicate that the vehicle 111 is stopped, and the motion sensor 140 must indicate that there is no nearby vehicle in motion in order that the door interlock 157 is caused to enable the door 127 to its unlocked position.

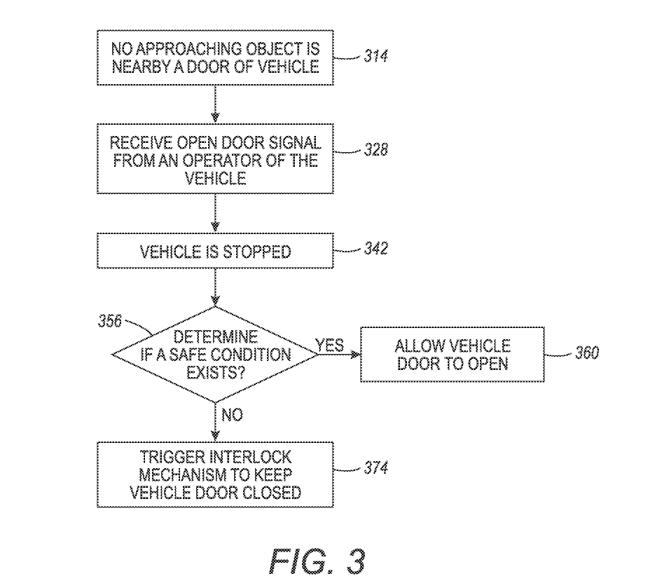

FIG. 3 is a flow diagram illustrating a processing flow of an exemplary method herein. In item 314, the safety interlock system determines whether there is an approaching object in motion nearby the door of the vehicle. The motion of the object is determined to be along a path that would pass in front of the door approximately perpendicular to a direction of pedestrian egress from the vehicle. At 328, the safety interlock system receives an open door signal from the driver of the vehicle. At 342, the safety interlock system determines whether the vehicle is stopped. The safety interlock system determines if a safe condition exists, at 356. A safe condition exists when the vehicle is stopped, the driver has signaled to open the door, and there is no nearby object moving toward the stopped vehicle along a path that would pass in front of the door approximately perpendicular to a direction of pedestrian egress from the vehicle. If such a condition exists, at 360, the safety interlock system allows the vehicle door to be opened. Otherwise, at 374, the safety interlock system triggers the interlock mechanism to keep the vehicle door closed.

It is thusly appreciated that the safety interlock system disclosed herein attempts to ensure that before the door 127 of the vehicle can be opened certain safe conditions exist. To achieve this, the safety interlock system requires that the vehicle be in a stationary position, that the driver has considered the situation and it appears safe to open the door 127, and that an automatic motion sensor 140 has determined that there is no object in motion near to the door. Hence, it is understood that the safety interlock system as disclosed herein has the potential to reduce injuries and fatalities related to school buses and other public transportation vehicles.

It should be understood that the terms “processor” and “logic processor” as used herein comprises a computerized device adapted to perform (i.e., programmed to perform, configured to perform, etc.) the above described system operations. Preferably, this processor or logic processor comprises a programmable, self-contained, dedicated mini-computer having a central processor unit (CPU) and electronic storage. Computerized devices that include chip-based central processing units (CPU's), comparators, processors, etc. are well-known and readily available devices produced by manufacturers such as Dell Computers, Round Rock Tex., USA and Apple Computer Co., Cupertino Calif., USA. Such computerized devices commonly include input/output devices, power supplies, processors, electronic storage memories, wiring, etc., the details of which are omitted herefrom to allow the reader to focus on the salient aspects of the devices and methods described herein.

The terminology used herein is for the purpose of describing particular devices and methods only and is not intended to be limiting of this disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In addition, terms such as “right”, “left”, “vertical”, “horizontal”, “top”, “bottom”, “upper”, “lower”, “under”, “below”, “underlying”, “over”, “overlying”, “parallel”, “perpendicular”, etc., used herein, are understood to be relative locations as they are oriented and illustrated in the drawings (unless otherwise indicated). Terms such as “touching”, “on”, “in direct contact”, “abutting”, “directly adjacent to”, etc., mean that at least one element physically contacts another element (without other elements separating the described elements). Further, the terms ‘automated’ or ‘automatically’ mean that once a machine or a user starts a process, one or more machines perform the process without further input from any user.

The corresponding structures, materials, acts, and equivalents of all means or step plus function elements in the claims below are intended to include any structure, material, or act for performing the function in combination with other claimed elements as specifically claimed. The descriptions of the various devices and methods of the present disclosure have been presented for purposes of illustration, but are not intended to be exhaustive or limited to the devices and methods disclosed. Many modifications and variations will be apparent to those of ordinary skill in the art without departing from the scope and spirit of the described devices and methods. The terminology used herein was chosen to best explain the principles of the devices and methods, the practical application or technical improvement over technologies found in the marketplace, or to enable others of ordinary skill in the art to understand the devices and methods disclosed herein.

It will be appreciated that the above-disclosed and other features and functions, or alternatives thereof, may be desirably combined into many other different systems or applications. Those skilled in the art may subsequently make various presently unforeseen or unanticipated alternatives, modifications, variations, or improvements therein, which are also intended to be encompassed by the following claims. Unless specifically defined in a specific claim itself, steps or components of the systems and methods herein should not be implied or imported from any above example as limitations to any particular order, number, position, size, shape, angle, color, temperature, or material.

What is claimed is:

1. A vehicle door interlock system, comprising:
a logic processor operatively connected to a door of a vehicle, said door being positioned with respect to a pedestrian egress path out of said vehicle; and
a plurality of inputs to said logic processor, said plurality of inputs comprising:
a first input comprising a velocity detection signal from a velocity sensor operatively connected to said vehicle determining a velocity of said vehicle;
a second input comprising an object detection signal from a motion sensor attached to an outside portion of said vehicle, said motion sensor determining movement of an object relative to said pedestrian egress path; and
a third input comprising an open door signal from an operator of said vehicle,
said logic processor providing a signal to an interlock device operatively connected to said door of said vehicle, said interlock device preventing said door from being opened when said logic processor determines any one of: said vehicle moving based on said velocity detection signal, said object being at a distance and moving in a direction to intersect said pedestrian egress path based on said object detection signal, and lack of said open door signal from said operator of said vehicle.

2. The vehicle door interlock system according to claim 1, said motion sensor comprising one of a radar system and a LIDAR system.

3. The vehicle door interlock system according to claim 1, said interlock device preventing said door from being opened when said motion sensor detects said object being within a preselected size range and said object moving above a preselected speed.

4. The vehicle door interlock system according to claim 1, said velocity detection signal verifying said vehicle travelling at less than a predetermined speed.

5. The vehicle door interlock system according to claim 1, said velocity sensor comprising a tachometer operatively connected to one or more axles of said vehicle.

6. The vehicle door interlock system according to claim 1, said plurality of inputs further comprising one of:
a fourth input comprising a signal indicating brakes of said vehicle being applied; and
a fifth input comprising a signal indicating a transmission of said vehicle being in a neutral position,
said logic processor providing said signal to said interlock device when said logic processor determines any one of: lack of said signal indicating brakes being applied and lack of said signal indicating said transmission being in a neutral position.

7. An apparatus, comprising:
a first sensor operatively connected to a vehicle, said first sensor determining a velocity of said vehicle;
a second sensor attached to an outside portion of said vehicle, said second sensor detecting movement of an object relative to a pedestrian egress path out of said vehicle; and
a logic system operatively connected to said first sensor and said second sensor,
said logic system providing a signal to an interlock device operatively connected to a door of said vehicle, said interlock device preventing said door from being opened when said logic system determines one of: said vehicle being moving based on input from said first sensor, and said object being at a distance and moving in a direction to intersect said pedestrian egress path based on input from said second sensor.

8. The apparatus according to claim 7, said first sensor comprising a tachometer operatively connected to one or more axles of said vehicle.

9. The apparatus according to claim 8, said first sensor verifying said vehicle travelling at a rate of speed less than a predetermined speed.

10. The apparatus according to claim 7, said second sensor comprising one of a radar system and a LIDAR system.

11. The apparatus according to claim 7, said object being within a preselected size range and said object moving above a preselected speed.

12. The apparatus according to claim 7, further comprising an open door switch operatively attached to said vehicle,
said logic system providing said signal to said interlock device when said logic system determines a lack of an open door signal from an operator of said vehicle.

13. An interlock system for a vehicle door, comprising:
a sensor attached to an outside portion of a vehicle, said sensor detecting an object moving toward said vehicle when said vehicle is stationary; and
a processor operatively connected to said sensor,
responsive to said sensor determining said object being within a predetermined distance from said vehicle door and said object travelling along a path that would pass in front of said door approximately perpendicular to a direction of pedestrian egress from said vehicle, said processor triggering an interlock mechanism preventing said vehicle door from being opened.

14. The interlock system according to claim 13, said sensor comprising one of a radar system and a LIDAR system.

15. The interlock system according to claim 13, said interlock mechanism preventing said door from being opened when said sensor detects said object being within a preselected size range and said object moving above a preselected speed.

16. The interlock system according to claim 13, further comprising a velocity detection apparatus connected to said vehicle, said velocity detection apparatus being operatively connected to said processor,
responsive to said velocity detection apparatus determining said vehicle being in motion, said processor triggering said interlock mechanism to keep said vehicle door closed.

17. The interlock system according to claim 16, said velocity detection apparatus verifying said vehicle travelling at a rate of speed less than a predetermined speed.

18. The interlock system according to claim 16, said velocity detection apparatus comprising one of a tachometer operatively attached to one or more axles of said vehicle and a velocity sensor operatively connected to said vehicle.

19. The interlock system according to claim 13, further comprising an open door switch operatively connected to said processor,
responsive to lack of an open door signal from said open door switch, said processor triggering said interlock mechanism to keep said vehicle door closed.

20. A door control apparatus, comprising:
an interlock mechanism operatively connected to a door of a vehicle;
a velocity sensor operatively connected to said vehicle, said velocity sensor determining a velocity of said vehicle;
a motion sensor attached to an outside portion of said vehicle, said motion sensor detecting movement of an object moving toward said vehicle; and
a processor operatively connected to said velocity sensor and said motion sensor, said processor triggering said interlock mechanism to prevent said door from being opened when said processor determines said vehicle is moving based on input from said velocity sensor and said object is within a predetermined distance from said vehicle and travelling along a path that would pass in front of said door approximately perpendicular to a direction of pedestrian egress from said vehicle based on input from said motion sensor.

21. The door control apparatus according to claim 20, said motion sensor comprising one of a radar system and a LIDAR system.

22. The door control apparatus according to claim 20, said interlock mechanism preventing said door from being opened when said motion sensor detects said object being within a preselected size range and said object moving above a preselected speed.

23. The door control apparatus according to claim 20, said velocity sensor verifying said vehicle travelling at a rate of speed less than a predetermined speed.

24. The door control apparatus according to claim 20, said velocity sensor comprising a tachometer operatively connected to one or more axles of said vehicle.

25. The door control apparatus according to claim 20, further comprising an open door switch operatively connected to said processor, responsive to lack of an open door signal from said open door switch, said processor triggering said interlock mechanism to keep said door closed.
